(19) United States
(12) Patent Application Publication
(10) Pub. No.: US 2006/0085964 A1
(43) Pub. Date: Apr. 27, 2006

(54) Portable hydraulic bushing press device and related method of manufacturing thereof

(76) Inventor: Raymond A. Brown, Princeton, TX (US)

Correspondence Address: RAYMOND A. BROWN, 4448 COUNTY ROAD 895, PRINCETON, TX, 75407, US

(21) Appl. No.: 10/972,833

(22) Filed: Oct. 25, 2004

(51) Int. Cl. B23P 11/00

(52) U.S. Cl. 29/434; 29/525.01

(57) ABSTRACT

Disclosed herein is a portable hydraulic press comprising a c-frame having a throat and first and second ends, the first and second ends locatable about a part to be pressed and a receiving structure. The press also includes a hydraulic assembly coupled to the c-frame and having a hydraulic ram configured to move through the first end and towards and away from an interior surface of the second end of the c-frame when the press is operated. It further includes a first installation cup coupled to the hydraulic ram, and having engaging surfaces designed to conform to exterior surfaces of an exterior surface of either the part or the receiving structure, and a second installation cup coupled to the interior surface of the second end of the c-frame and having engaging surfaces designed to conform to exterior surfaces of the other of the exterior surface of the part or the receiving structure. A hydraulic pump is coupled to the hydraulic assembly to operate the press.

### TECHNICAL FIELD

Disclosed embodiments herein relate generally to hydraulic devices, and more particularly to a portable hydraulic bushing press and related method of pressing bushings in, for example, automobile suspension assemblies.

### BACKGROUND

Since in the inception of the automobile as the preferred and most popular means of transportation, automobile manufacturers have continued to strive to improve various facets of the automobile, including ride quality. Key to improving ride quality is the suspension system of the automobile, which is engineered to absorb any of a number of bumps or other hazards found on and off today's roads. As such suspension systems move to absorb these hazards, so that the passengers do not absorb them, components within the suspension system continuously move and pivot, as per their design. For example, the frames (e.g., “A-frames”) in modern suspension systems are typically pivotally coupled to the automobile's chassis, and are configured to pivot during operation. To “soften” this pivot, and thus further improve ride quality, the frames are usually coupled to specific points on the chassis using specially designed and shaped bushings.

However, in the continued pursuit of ride quality, the composition of the bushings typically comprises some type of soft compound, such as rubber or polyurethane. Unfortunately, while such materials have greatly improved ride quality, these materials eventually break down under the stress of the suspension system's operation, and have to be replaced. Such bushing replacement has traditionally been accomplished by an experienced automotive repair shop, since both the old and new bushings require high pressure devices, traditionally found only in such shops. As technology in this field has improved, some portable pressing devices have been developed, expanding the job of bushing replacement to mobile automobile repair services and even home mechanics.

Conventional portable bushing pressing devices configured to accomplish the installation of specific bushings in certain components have existed for some time. However, these devices typically suffer from numerous deficiencies. For example, such devices are typically limited to manual operation, resulting in extended installation times, as well as requiring the operator installing the bushings to manipulate the components of the device and the bushing components during the actual installation operation. As a result, the technician's fingers and hands are necessarily placed in harm's way during the installation operation, which may lead to serious injuries to the technician. Conventional devices are also typically driven by a threaded lead screw inserted through the center of the bushing(s) to be installed, the automobile component to receive the new bushing, and any installation tools or “cups” specially designed to hold the bushings and suspension component in place during the installation operation. Unfortunately, modem metallurgical and forging techniques have been unable to create a threaded lead screw capable of surviving numerous installation operations. For example, this inventor has experienced repeated failure in such conventional installation devices after as few as five uses.

Moreover, the manual nature of such conventional devices also results in a tedious and labor-intensive task. While portable hydraulic devices have been developed over the years, their general-purpose design greatly limits their use for specialized tasks. For example, the general design of such hydraulic devices typically prevents them from reaching in certain hard-to-reach locations or around uniquely shaped components. In addition, in many cases employing such general purpose devices, without the specially designed tooling typically required for certain specialized tasks, such as the removal and replacement of suspension bushings, often results in damage to the new part being installed or to the component in which the part is to be installed, or simply results in the inability to accomplish the task. Accordingly, these and other deficiencies are overcome by the novel device and related methods disclosed herein.

### BRIEF SUMMARY

Disclosed herein are embodiments of a portable hydraulic bushing press and related methods of pressing bushings in various components, such as automobile suspension components. The complete portable hydraulic bushing press system is configured to accomplish the installation of specific bushings in specific situations that cannot be done by conventional devices because existing equipment cannot perform the required tasks. The task is to quickly and safely insert bushings in suspension components of vehicles that demand extraordinary pressure due to close tolerances and a tight fit. This pressure is exerted on a specially reinforced “c-frame” utilizing specially designed cups that interface with the bushing and vehicle suspension component through integration with a hydraulic ram device and operator controlled foot pump connected to a source of pressurized air that allows for the bushing to be safely inserted in the fixture minimizing time and effort.

In one aspect, the portable hydraulic press comprises a c-frame having a throat and first and second ends, the first and second ends locatable about a part to be pressed and a receiving structure configured to receive the part. In this embodiment, the portable hydraulic press also includes a hydraulic assembly coupled to an exterior surface of the first end and having a hydraulic ram configured to move through the first end and towards and away from an interior surface of the second end of the c-frame when the hydraulic assembly is operated. It further includes a first installation cup coupled to an exposed end of the hydraulic ram, and having engaging surfaces designed to conform to exterior surfaces of an exterior surface of either the part or the receiving structure, and a second installation cup coupled to the interior surface of the second end of the c-frame and having engaging surfaces designed to conform to exterior surfaces of the other of the exterior surface of the part or the receiving structure. A hydraulic pump is coupled to the hydraulic assembly and configured to provide hydraulic pressure to the hydraulic assembly so as to cause the hydraulic ram to press the part into the receiving structure.

In another aspect, a method of manufacturing a portable hydraulic press is disclosed. In one embodiment, the method comprises providing a c-frame having a throat and first and second ends on opposing ends of the throat, the first and second ends locatable about a part to be pressed and a receiving structure configures to receive the part. In this embodiment, the method also provides coupling a hydraulic assembly to an exterior surface of the first end, wherein the hydraulic assembly comprises a hydraulic ram configured to move through the first end and towards and away from an interior surface of the second end of the c-frame when the hydraulic assembly is operated. Also, the method includes coupling a first installation cup to an exposed end of the hydraulic ram, the first installation cup having engaging surfaces designed to conform to exterior surfaces of an exterior surface of either the part or the receiving structure, and coupling a second installation cup to the interior surface of the second end of the c-frame, the second installation cup having engaging surfaces designed to conform to exterior surfaces of the other of the exterior surface of the part or the receiving structure. Also in this embodiment, the method provides coupling a hydraulic pump to the hydraulic assembly to provide hydraulic pressure to the hydraulic assembly so as to cause the hydraulic ram to press the part into the receiving structure.

### BRIEF DESCRIPTION OF THE DRAWINGS

Reference is now made to the following detailed description of the preferred embodiments, taken in conjunction with the accompanying drawings. It is emphasized that various features may not be drawn to scale. In fact, the dimensions of various features may be arbitrarily increased or reduced for clarity of discussion. In addition, it is emphasized that some components may not be illustrated for clarity of discussion. Reference is now made to the following descriptions taken in conjunction with the accompanying drawings, in which:

FIG. 1 illustrates multiple views of the c-frame of the portable hydraulic bushing press disclosed herein;

FIG. 2 illustrates multiple installation cups for use with the portable hydraulic bushing press disclosed herein and specially designed to receive multiple shaped suspension bushings;

FIG. 3 illustrates one embodiment of the portable hydraulic bushing press with some accompanying components;

FIG. 4 illustrates one embodiment of the portable hydraulic bushing press with the portable hydraulic system;

FIG. 5 illustrates another embodiment of the portable bushing press with a lead screw;

FIG. 6 illustrates a close view of one embodiment of a guide connector for use with other components in the portable hydraulic bushing press; and

FIG. 7 illustrates a close view of multiple components of the portable hydraulic bushing press employing the guide connector of FIG. 6.

### DETAILED DESCRIPTION OF PREFERRED EMBODIMENTS

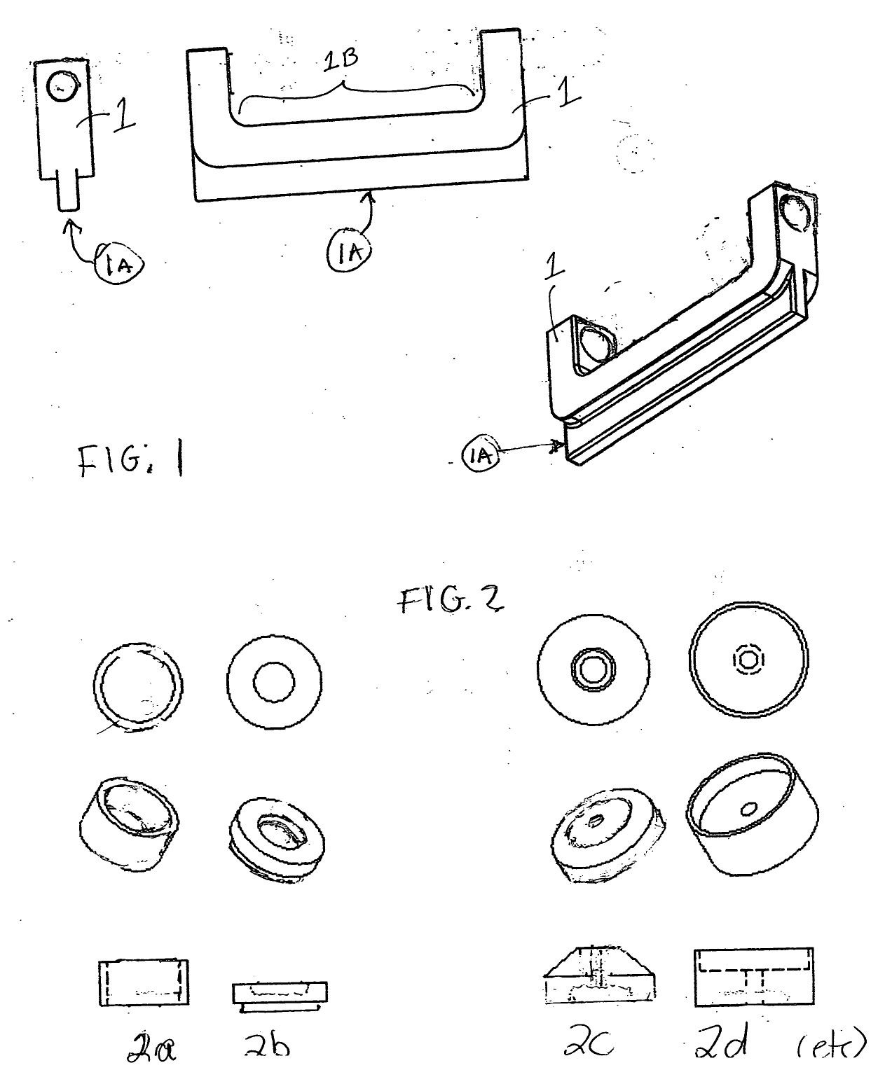

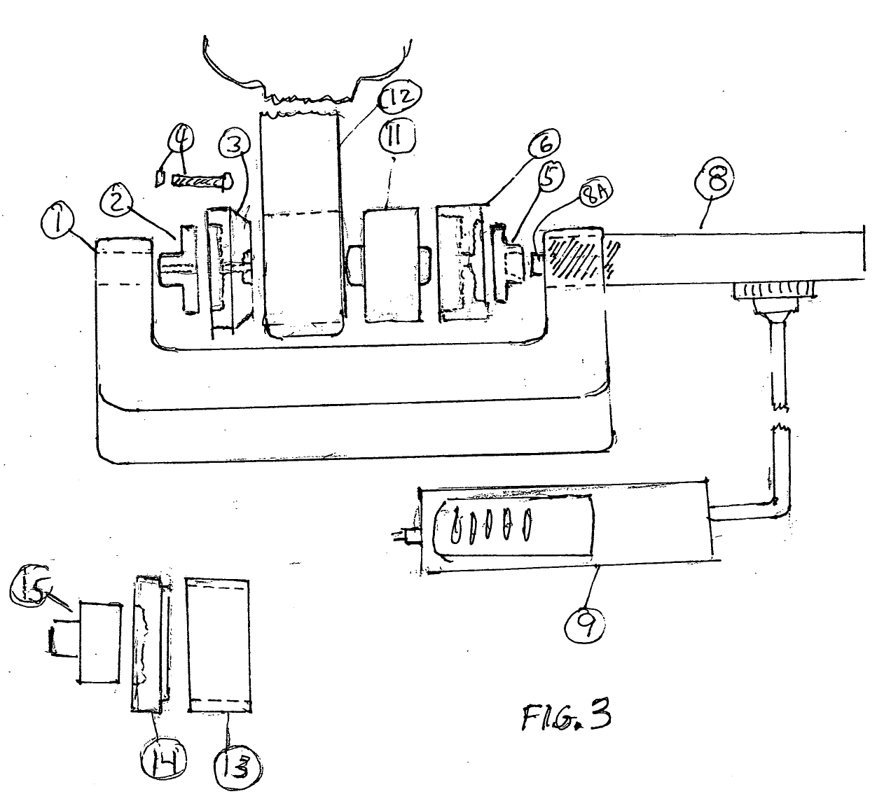

Looking initially at FIG. 1, a primary device (1) is illustrated as a c-frame that has been specially reinforced with an outside rib (1A) running the length of the frame 1 that not only increases the strength of the frame 1 but also minimizes weight. In addition, the rib 1A provides a flat and sturdy appendage, not found in conventional die-cast c-frames, which can be clamped or vised to a stable surface. This primary device 1 is coordinated with installation cups 2a, 2b, 2c, 2d, etc., which are illustrated in FIG. 2, that are specially designed to fit specific bushing 11 types and sizes.

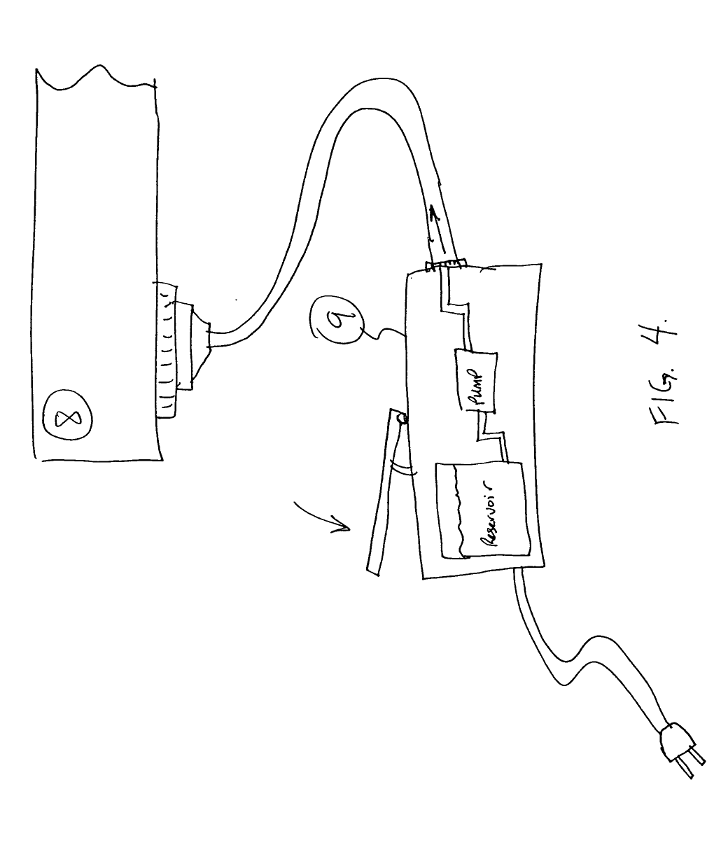

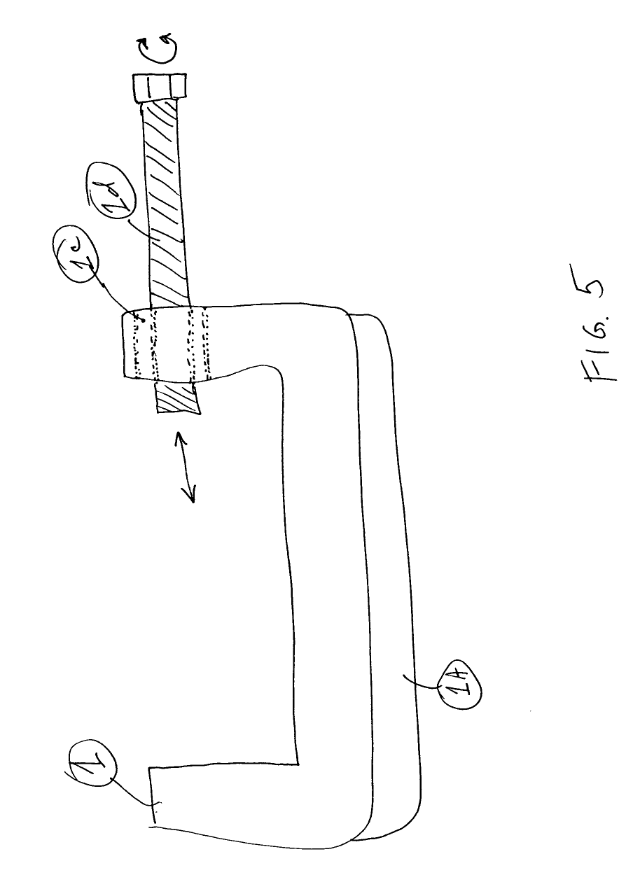

In FIG. 3, it is illustrated that the bushing 11 is placed within the arrangement of the primary device 1 and frame fixture 12 and cups 3, 6, and with the addition of the hydraulic assembly 8, having a hydraulic ram 8A extending therefrom during operation, connected to a hydraulic foot control pump 9. The pump 9 is illustrated in more detail in FIG. 4, and allows the bushing 12 to be quickly and safely inserted into the vehicle suspension component 12. A spacer or adapter 2, 5 may be employed at either end of the c-frame 1 to assist in the holding the installation cups 3, 6, for example, permit quick removal and replacement of cups with different cups (e.g., cup 14) as the need arises. In other embodiments, the installation cups 3, 6 are coupled to the spacers 2, 5 using bolts or other types of fasteners (e.g., bolt and nut 4). In addition, even the spacers 2, 5 may be replaceable with larger spacers, (e.g., spacer 15) if needed. Moreover, the working ends of the cups 3, 6 may also be configured to receive spacers or adapters (e.g., spacer 13), as each specific bushing application demands.

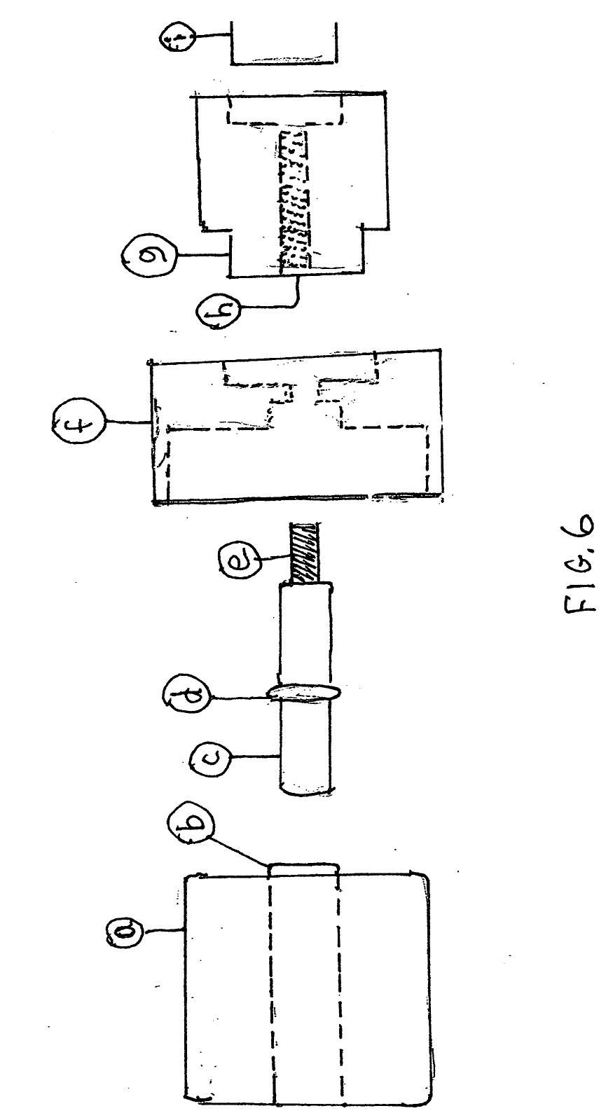

Turning briefly to FIG. 5, an alternative use is enabled with the treaded adapter 1C and thrust screw 1D that may be hand operated in the absence of power sources. The threaded adapter 1C may be provided to screw into the same threads that the ram assembly 8 used to engage the c-frame 1, and then have a different thread pattern within that matches the threads of the thrust screw 1D.

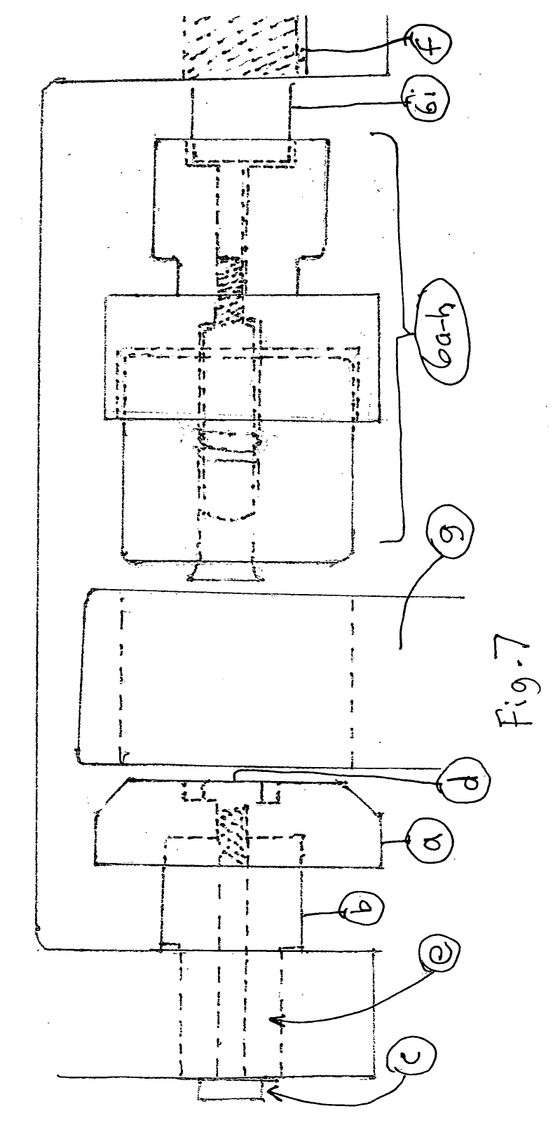

Turning now to FIG. 6, a guide connector is illustrated as part of the overall press assembly. The threaded end (6e) of the guide connector (6c,d,e) is inserted through the appropriate cup (6f) and then screwed (6h) into a threaded ram extension (6g) that will be connected to the piston end of the ram (6i). Then the unthreaded end of the guide connector (6c) is inserted into the hollow metal tube (6b) of the bushing 11 that is to be installed (6a) with the o-ring (6d) on the guide connector gripping the inside of the hollow metal tube as the bushing is seated into the sending cup (6f). Then this entire sending sub assembly is ready to be placed in the portable bushing frame along with the receiving cup assembly that sits on the opposite side of the vehicle frame assembly installation opening. The resulting assembly of cups and bushing that are joined together allows the operator the freedom and safety of keeping hands away from the immediate area of the installation point while the guide connector and tapered receiving cup do the positioning work of several hands.

Turning finally to FIG. 7, another embodiment of the portable hydraulic press assembly is disclosed. A tapered installation cup (7a) is attached to the extension (7b) with a threaded hex bolt (7c) and retaining nut (7d) after which this subassembly (7a-c) is inserted into the c-frame (7e). Corresponding sub-assembly (6a-h) is attached to a ram end (6i), which is threadedly attached to the bushing c-frame (7f), placing both sub-assemblies (7a-d and 6a-h) on opposite sides of the vehicle suspension component (7g). The ram, which is attached to a pump and compressed air (or other hydraulic fluid) source, is ready to be activated to push assembly 6a-h towards assembly 7a-d ultimately seating 6a inside the vehicle suspension component (7g).

Previous designs provide only for manual insertion of such specially designed and shaped bushings in automobile suspension components. Of the currently available hydraulic devices, deficiencies in their use include either non-portability, lack of strength due to conventional die-cast construction, and inability for use with the various designs and shapes of the bushings to be pressed into the suspension components. Thus, as discussed above, conventional portable bushing pressing devices configured to install such specific bushings are typically limited to manual operation, resulting in extended installation times, as well as requiring the operator installing the bushings to manipulate the components of the device and the bushing components during the actual installation operation. As a result, the operator's fingers and hands are necessarily placed in harm's way during the installation operation, which may lead to serious injuries to the operator.

In addition, the disclosed device also eliminates the use of a manual threaded lead screw, thus overcoming the rapid failure found in conventional pressing devices, as well as eliminating the tedious and labor-intensive task of employing a manual device. Moreover, the disclosed device overcomes the deficiencies of current portable hydraulic devices. For example, the general design of such hydraulic devices typically prevents them from reaching in certain hard-to-reach location or around uniquely shaped components. In addition, in many cases employing such general purpose devices, without the specially designed tooling typically required for certain specialized tasks, such as the removal and replacement of suspension bushings, often results in damage to the new part being installed or to the component in which the part is to be installed, or simply results in the inability to accomplish the task. Furthermore, even if a general purpose portable hydraulic device can be modified to somewhat work with the necessary specialized tooling for this type of installation, the disclosed device provides specially designed mounting bolts to couple the cups to the c-frame. With these mounting bolts, the operator need no longer worry about the cups moving during the installation operation, which may cause damage to the bushing being installed or even to the operator himself.

Still further, the reinforcement rib of the c-frame of the disclosed device achieves a structural integrity comparable to frames weighing as much as twice the disclosed device, thus improving portability and ease of use by the operator. The larger throat of the c-frame along with specifically designed cups allows for the accomplishment of virtually any and all power assisted bushing installations. The threaded interlinking of the cups to adapters or to each other frees the operator's hands from dangerous areas as the pressure is applied. Moreover, the tapered receiving cups provide self-centering of the bushing as it is inserted into vehicle frame apparatus, avoiding restarting the process or having to manually hold the bushing in place once pressure applied. The specially designed cups employ twice the thickness of bearing cups and are heat treated to resist bending, cracking or sudden explosion which could result in injury to an operator, as well as destruction of the bushing or suspension component. Also, in certain embodiments, specially designed mounting bolts may be employed to not only couple the cups to the c-frame and/or hydraulic ram end, but also to secure the bushing to be installed to the cup, thus preventing the movement or loss of the bushing during its installation and eliminating the risk to an operator required to hold the bushing in position during the installation.

While various embodiments of the portable hydraulic bushing pressing device according to the principles disclosed herein, as well as related methods of pressing bushing, have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from patent applications related to this provisional patent application. Moreover, the above advantages and features are provided in described embodiments, but shall not limit the application of such claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from patent applications related to this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth any such claims. Furthermore, any reference in this disclosure to “invention” in the singular should not be used to argue that there is only a single point of novelty in this disclosure. Multiple inventions may be set forth according to the limitations of the multiple claims associated with this disclosure, and the claims accordingly define the invention(s), and their equivalents, that are protected thereby. In all instances, the scope of such claims shall be considered on their own merits in light of their specification and this disclosure, but should not be constrained by the headings set forth herein.

What is claimed is:

1. A portable hydraulic press, comprising:
a c-frame having a throat and first and second ends on opposing ends of the throat, the first and second ends locatable about a part to be pressed and a receiving structure configured to receive the part;
a hydraulic assembly coupled to an exterior surface of the first end and having a hydraulic ram configured to move through the first end and towards and away from an interior surface of the second end of the c-frame when the hydraulic assembly is operated;
a first installation cup coupled to an exposed end of the hydraulic ram, and having engaging surfaces designed to conform to exterior surfaces of an exterior surface of either the part or the receiving structure;
a second installation cup coupled to the interior surface of the second end of the c-frame and having engaging surfaces designed to conform to exterior surfaces of the other of the exterior surface of the part or the receiving structure; and
a hydraulic pump coupled to the hydraulic assembly and configured to provide hydraulic pressure to the hydraulic assembly so as to cause the hydraulic ram to press the part into the receiving structure.

2. A portable hydraulic press according to claim 1, wherein one of the installation cups comprises a tapered surface configured to engage the exterior surface of the part or the receiving structure so as to center the part or the receiving structure with respect to the hydraulic ram.

3. A portable hydraulic press according to claim 1, wherein the hydraulic ram is threadedly coupled to, and removable from, the c-frame.

4. A portable hydraulic press according to claim 1, further comprising a screw having threads configured to threaded engage the c-frame in place of the hydraulic assembly and move through the first end of the c-frame and towards and away from an interior surface of the second end of the c-frame when the screw is turned.

5. A portable hydraulic press according to claim 4, further comprising a tool-engageable surface at an exterior end of the screw engageable to turn the screw.

6. A portable hydraulic press according to claim 1, further comprising a strengthening rib along the length of an exterior surface of the throat of the c-clamp.

7. A portable hydraulic press according to claim 1, further comprising a foot-operated switch coupled to the hydraulic pump for operating the pump.

8. A portable hydraulic press according to claim 1, wherein at least one of the installation cups is removably coupled to the corresponding exposed end of the hydraulic ram or interior surface of the second end of the c-frame using a fastener.

9. A portable hydraulic press according to claim 8, wherein the fastener is a screw passed through a center of the at least one installation cup and configured to threadedly engage exposed end of the hydraulic ram or interior surface of the second end of the c-frame.

10. A portable hydraulic press according to claim 1, wherein the engaging surface of the first or second installation cup further comprises a structure configured to hold the part to the first or second installation cup during operation of the hydraulic assembly.

11. A method of manufacturing a portable hydraulic press, the method comprising:
providing a c-frame having a throat and first and second ends on opposing ends of the throat, the first and second ends locatable about a part to be pressed and a receiving structure configures to receive the part;
coupling a hydraulic assembly to an exterior surface of the first end, wherein the hydraulic assembly comprises a hydraulic ram configured to move through the first end and towards and away from an interior surface of the second end of the c-frame when the hydraulic assembly is operated;
coupling a first installation cup to an exposed end of the hydraulic ram, the first installation cup having engaging surfaces designed to conform to exterior surfaces of an exterior surface of either the part or the receiving structure;
coupling a second installation cup to the interior surface of the second end of the c-frame, the second installation cup having engaging surfaces designed to conform to exterior surfaces of the other of the exterior surface of the part or the receiving structure; and
coupling a hydraulic pump to the hydraulic assembly to provide hydraulic pressure to the hydraulic assembly so as to cause the hydraulic ram to press the part into the receiving structure.

12. A method according to claim 11, wherein one of the installation cups comprises a tapered surface configured to engage the exterior surface of the part or the receiving structure so as to center the part or the receiving structure with respect to the hydraulic ram.

13. A method according to claim 11, wherein coupling the hydraulic ram further comprises threadedly coupling the hydraulic assembly to the c-frame.

14. A method according to claim 11, further comprising coupling a screw having threads configured to threaded engage the c-frame in place of the hydraulic assembly, the screw moving through the first end of the c-frame and towards and away from an interior surface of the second end of the c-frame when the screw is turned.

15. A method according to claim 14, further comprising providing a tool-engageable surface at an exterior end of the screw engageable to turn the screw.

16. A method according to claim 11, further comprising providing a strengthening rib along the length of an exterior surface of the throat of the c-clamp.

17. A method according to claim 11, further comprising connecting a foot-operated switch to the hydraulic pump for operating the pump.

18. A method according to claim 11, wherein coupling the first or second installation cup further comprises removably coupling the first or second installation cup to the corresponding exposed end of the hydraulic ram or interior surface of the second end of the c-frame using a fastener.

19. A method according to claim 18, wherein the fastener is a screw passed through a center of the at least one installation cup and configured to threadedly engage exposed end of the hydraulic ram or interior surface of the second end of the c-frame.

20. A method according to claim 11, further comprises providing, on the engaging surface of the first or second installation cup, a structure configured to hold the part to the first or second installation cup during operation of the hydraulic assembly.
